(19) United States
(12) Patent Application Publication
(10) Pub. No.: US 2014/0000359 A1
(43) Pub. Date: Jan. 2, 2014

(54) OPERATING A THERMAL ANEMOMETER FLOW METER

(71) Applicant: LOS ROBLES ADVERTISING, INC., Monterey, CA (US)

(72) Inventors: Daniel R. Kurz, Salinas, CA (US); Bruce B. Burton, Royal Oaks, CA (US)

(73) Assignee: Los Robles Advertising, Inc., Monterey, CA (US)

(21) Appl. No.: 13/869,953

(22) Filed: Apr. 24, 2013

Related U.S. Application Data
(60) Provisional application No. 61/666,432, filed on Jun. 29, 2012.

(51) Int. Cl. G01F 1/68

(52) U.S. Cl. CPC G01F 1/68
USPC 73/204.11

(57) ABSTRACT

An operating mode for a thermal anemometer flow sensor is provided so the flow sensor is operable in the presence of a high level of liquid mist without a significant error in flow reading from the liquid mist.

### CROSS REFERENCE TO RELATED APPLICATION

This application claims priority to U.S. Provisional Patent Application No. 61/666,432, attorney docket no. KII-HOH-PV, filed Jun. 29, 2012, which is incorporated by reference in its entirety.

### BACKGROUND

Thermal anemometer type flow meters have a very wide dynamic range, 100:1 and in some cases up to 1000:1. In addition, they have good durability, good accuracy, and high repeatability, and they have long proven themselves in the measurement of dry gas flow in a variety of applications. However, thermal anemometer type flow meters are very sensitive to liquid in the gas stream since any liquid contacting the sensor probes will cause a high reading due to the vaporization of the liquid as it impacts the surface of the heated portion. In fact, the ISO (International Standards Organization) in published standard 14164 for the “Stationary source emissions—Determination the volume flow rate of gas streams in ducts—Automated method,” Section 4.3, remarks that thermal anemometer flow sensors “cannot be used in ducts where condensing liquid droplets are present in the gas stream.” Nonetheless, the significant advantages of a thermal anemometer type flow meter make it highly desirable to develop one that can operate in wet gas flows and measure properties such as mass flow and vapor phase velocity.

### BRIEF DESCRIPTION OF THE DRAWINGS

In the drawings:

FIG. 1 is a side view of a wet gas flow meter;

FIG. 2 shows the detail of a thermal anemometer sensor of FIG. 1;

FIG. 3 is a side view of a flow meter test system applied to the measurement of a wet gas stream;

FIG. 4 is a graph of test data from the flow meter test system of FIG. 3; and

FIG. 5 is a graph showing heat loss versus overheat due to liquid impacting the heated probe and heat loss from convective gas flow;

FIGS. 6A, 6B, 6C, and 6D are graphs of test data from a digester product gas duct; and

FIGS. 7A, 7B, and 7C are graphs of test data from a digester product gas duct, all arranged according to examples of the present disclosure.

Use of the same reference numbers in different figures indicates similar or identical elements.

### DETAILED DESCRIPTION

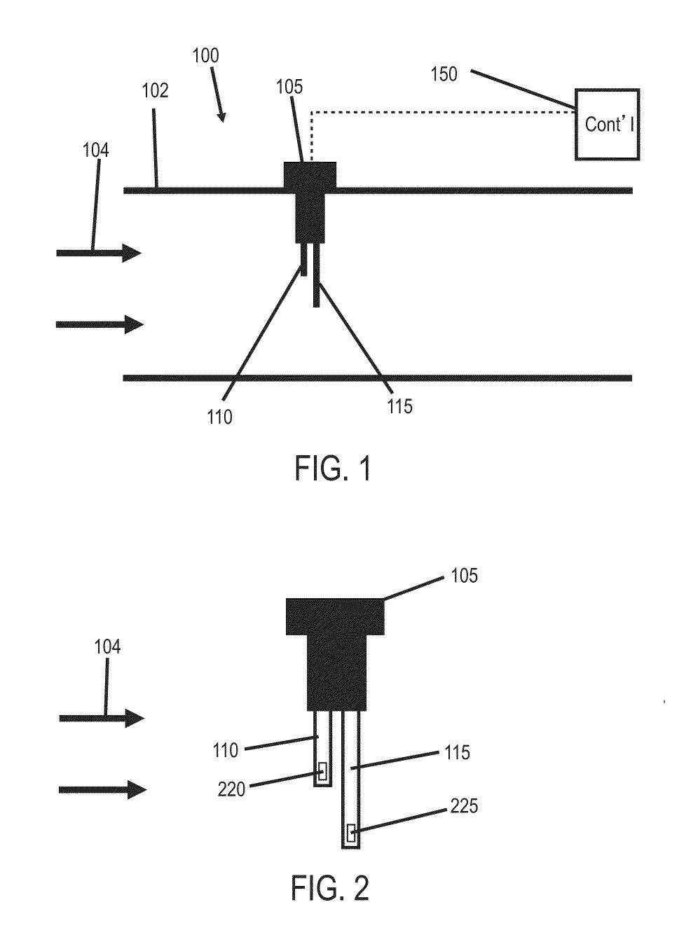

FIG. 1 is the side view of a wet gas flow meter 100 in one example of the present disclosure. A thermal anemometer sensor 105 is placed in a duct 102 with a wet gas stream 104. Sensor 105 has thermal anemometer probes 110 and 115 that are placed in the duct so that stream 104 passes over these probes. Probe 110 is placed generally upstream of probe 115. Probe 110 is a reference probe and measures the temperature of the flowing stream 104. Probe 115 is heated to some temperature above the stream temperature as measured by probe 110. Probes 110 and 115 are connected to a controller 150, which powers the probes and reads their values (e.g., voltages or currents). Although controller 150 is shown separate from sensor 105, it may be integrated with sensor 105. Controller 150 may be the universal controller described in U.S. Pat. Nos. 7,418,878 and 7,647,843.

In one mode of operation, probe 115 is heated to a fixed temperature difference “DeltaT” above reference probe 110. It should be noted that this DeltaT is sometimes referred to as “overheat” above the flow stream temperature and sometimes as “temperature rise” over the flow stream temperature. In the present disclosure, the term DeltaT encompasses to all of these terms and concepts. In the normal operation of thermal anemometer sensors such as sensor 105 in a dry gas flow, the power input to control their temperatures above the temperature of stream 104 would be a function of the mass flow rate of stream 104. As the mass flow of stream 104 increases, the power input to heated probe 115 would need to increase to maintain the DeltaT at the specified set value, for example 50° C. A calibration curve can be generated relating power to the dry gas mass flow rate. In the case where stream 104 is a two phase gas flow containing liquid droplets, any liquid droplet impacting heated probe 115 would also extract heat from the probe and the power input to the heated probe would increase to the additional power required to either heat the liquid coating the probe or to vaporize the liquid impacting the outer probe surfaces. The additional heat extraction leads to a large error in the flow reported by sensor 105. The additional power would be a function of the liquid mass flow rate in stream 104. The liquid would be vaporized in all cases were the temperature of heated probe 115 is above the boiling point of the liquid phase in the two phase flow stream 104. In cases where heated probe 115 is below the boiling point of the liquid and the liquid just coats and wets the outer probe surfaces, the heat input would also increase since the heat transfer coefficient from the probe surface to a liquid film is high compared to the heat transfer coefficient to a gas flowing past the probe. In a two phase steam flow, if the liquid and vapor are at equilibrium, then the liquid would vaporize if heated probe 115 is at any temperature above the equilibrium or saturated two phase stream.

FIG. 2 shows the details of sensor 105 in one example of the present disclosure. Reference probe 110 typically has a temperature sensing element 220 at the tip of this probe to measure the temperature of the flowing stream 104. Heated probe 115 has a heater and temperature sensing element 225 at the tip of this probe. Heater and temperature sensing element 225 may be two separate components such as a resistance heater heated by an electrical current and an RTD temperature sensing element whose resistance is measured to determine its temperature. Alternatively, these functions can be combined by using a single resistance element that is heated by an electrical current and whose resistance is measured to determine the temperature of heated probe 115. Typically, the heated portion of heated probe 115 is located at the tip of the probe but the heated region could extend over more of the probe length. In one example of sensor 105, reference probe 110 is shorter than heated probe 115 so that heat from heated probe 115 does not heat reference probe 110 and reference probe 110 measures more accurately the temperature of stream 104 that flows first over probe 110 and then probe 115. Alternative designs are possible with reference probe 110 longer then heated probe 115, with probe 115 positioned upstream of probe 110, and with probes 110 and 115 extending equally into the flow stream. In addition, sensor 105 is shown extending vertically into duct 102. In other examples for a horizontal duct, sensor 105 can be extended into the duct vertically from the bottom, horizontally from the side, or at other angles to the flow stream.

In general, the temperature rise of heated probe 115 over the temperature of reference probe 110, DeltaT, is selected based on the sensitivity of the temperature measuring elements 220 and 225, the accuracy of the electronic circuit used to measure the temperature difference, and the ability of the sensing probes to operate at high temperatures. In typical commercial thermal anemometer flow sensors, the DeltaT is in the range of 4 to 75° C. Operation at high DeltaT would require a heated probe that would withstand operation at higher temperatures especially in flow streams at high temperature where the heated probe would need to operate at a temperature equal to the flow stream temperature plus DeltaT. A number of references describe strategies for calculating flow from parameters including DeltaT. A review of these references and the literature shows no preference for a low DeltaT or a high DeltaT.

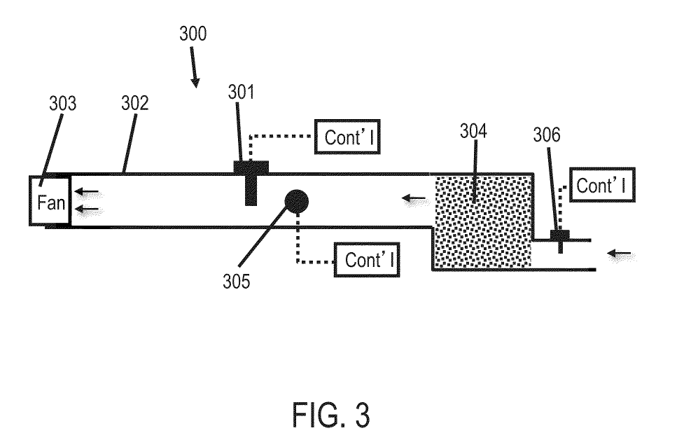

FIG. 3 is a side view of a flow meter test system 300 applied to the measurement of a two phase gas stream in one example of the present disclosure. In this example, the stream is air and the liquid phase is liquid water but the demonstration could also be done with any gas phase composition and any liquid phase dispersed in the gas phase flow. A first flow sensor 301 is installed in a four inch diameter pipe 302 connected to a fan 303 to provide an air flow over the sensor. Upstream of sensor 301 is installed a fog generator 304 that produces a fine fog like mist containing water droplets in the size range of 1 to 10 micrometers in diameter. A second flow sensor 305 is installed in duct 302 from the side at about the same axial distance from fog generator 304, and a third flow sensor 306 is installed in the duct at the air flow inlet upstream of the fog generator. Each of flow sensors 301, 305, and 306 is of the same or similar construction as flow sensor 105 (FIG. 2). Flow sensors 301, 305, and 306 are calibrated to read volumetric air flow in standard cubic meters per hour (SCMH). Fan 303 is adjusted to provide air flow velocity of about 200 SCMH.

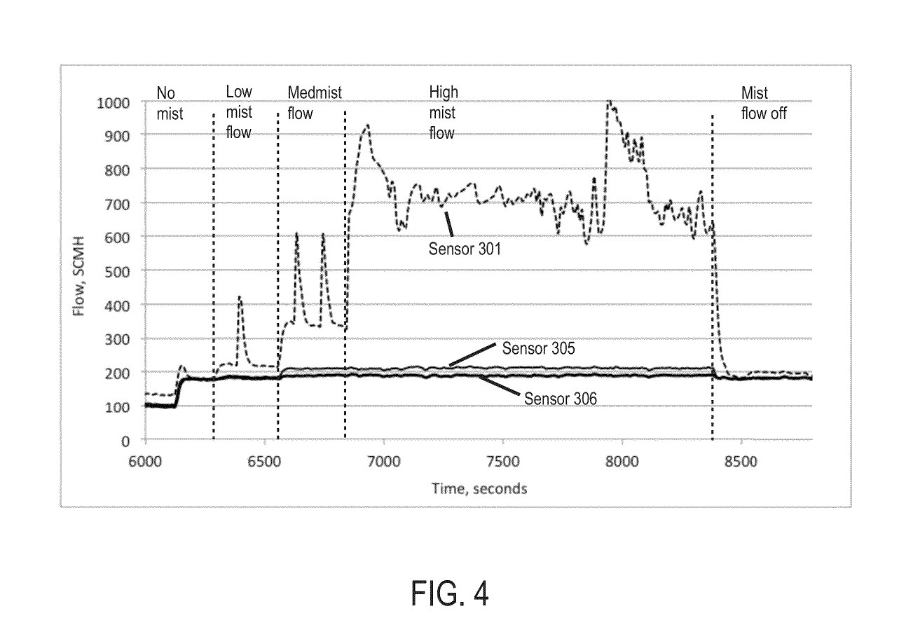

After recording a steady signal from all three flow sensors 301, 305, and 306, fog generator 304 was turned on and the flow sensor output are recorded as shown in FIG. 4 in one example of the present disclosure. From 6,100 seconds (s) to about 9,000 s, the fan speed and the air flow rate were held constant at about 200 SCMH. Fog generator 304 was turned on at a low fog generation rate at 6,300 s, a medium fog rate at 6,600 s, and a high fog rate at 6,900 s. As shown in FIG. 4, the signal from sensor 301 shows a very high erroneous signal when the fog is present in the flow stream as would be expected. With a high fog generation rate, the signal shows spikes as high as 1,000 SCMH and an average signal level of 600 to 800 SCMH. This is the expected behavior for a conventional thermal anemometer flow sensor. Sensor 301 was operated with a DeltaT of 50° C. and calibrated at this DeltaT in flowing air. Sensor 305 was operated with a DeltaT of 300° C. and calibrated at this DeltaT in flowing air. Unexpectedly the sensor operated with a DeltaT of 300° C. shows a relatively stable signal with only a slight increase in response compared to sensor 306 that measures the inlet air flow upstream of fog generator 304. The surprising behavior is that high DeltaT provides some immunity to the presence of a fine mist in the air stream. It is observed that even at a relatively high level of mist that causes substantial error in a conventional thermal anemometer sensor operated at a lower DeltaT, a thermal anemometer operated at high DeltaT showed a very low flow error.

The data shown in FIG. 4 demonstrates the innovative concept, which is the operation of a thermal anemometer flow sensor with a very high DeltaT, in the range of 100 to 1,000° C. or 200 to 600° C., provides the ability to minimize or eliminate the effect of a fine mist of liquid in a gaseous flow stream.

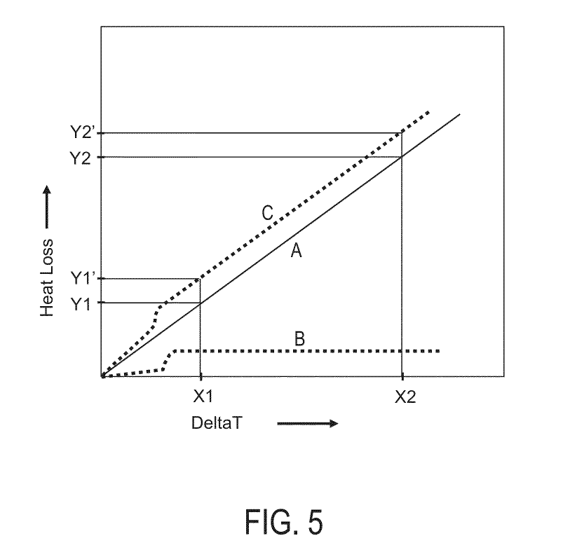

While it is unexpected that operating heated probe 115 at a high DeltaT above the fluid temperature should reduce and even eliminate the effect of liquid droplets in the gaseous stream, it can be understood by considering the following. FIG. 5 shows the heat loss from a heated probed in a constant velocity gas stream. As the DeltaT is increased along the abscissa, the heat loss from the heated probe, shown on the ordinate axis, due to convection to the gas flow increases approximately linearly as shown by curve A. If liquid droplets or a mist is present in the flow, the heat loss due to the liquid impacting the heated probe would have the general shape shown in curve B. At low DeltaT, where the probe temperature is below the boiling point of the liquid, the probe would lose heat as the liquid film is heated to the probe temperature, resulting in a slight rise in the heat loss to the liquid as the probe temperature (DeltaT) is increased. When the heated probe temperature reaches and passes the boiling point of the liquid, the heat loss will rise sharply as the liquid film on the probe is vaporized. As DeltaT is increased further, the heat loss due to the liquid will remain nearly constant. The total heat loss from the heated probe is shown as the sum of these two components, curve C. At some low DeltaT temperature such as X1, the error caused by the liquid, (Y1′−Y1)/Y1, would be large. At some high DeltaT temperature such as X2, the error due to the liquid would be small, (Y2′−Y2)/Y2). The magnitude of the error due to liquid droplets or mist will be a function of the magnitude of the DeltaT, the amount of liquid present in the gaseous stream, and the gas velocity.

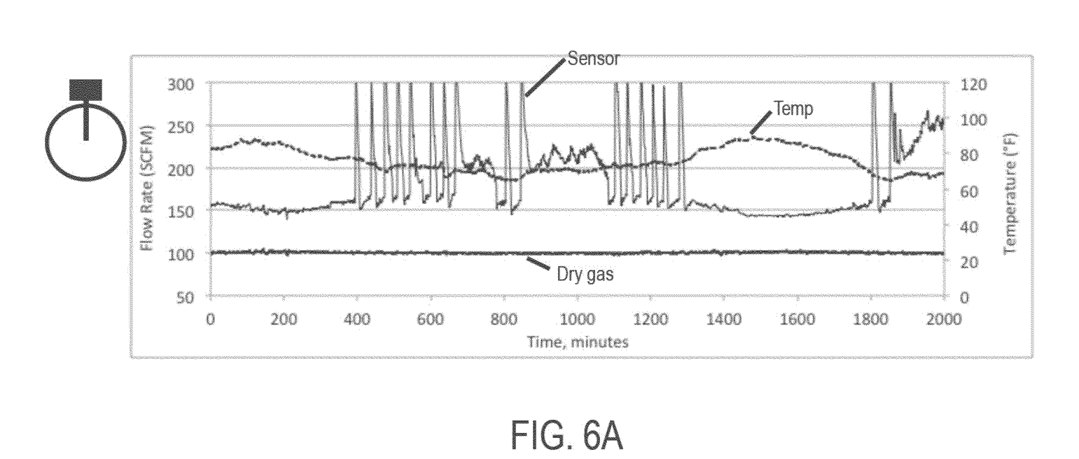

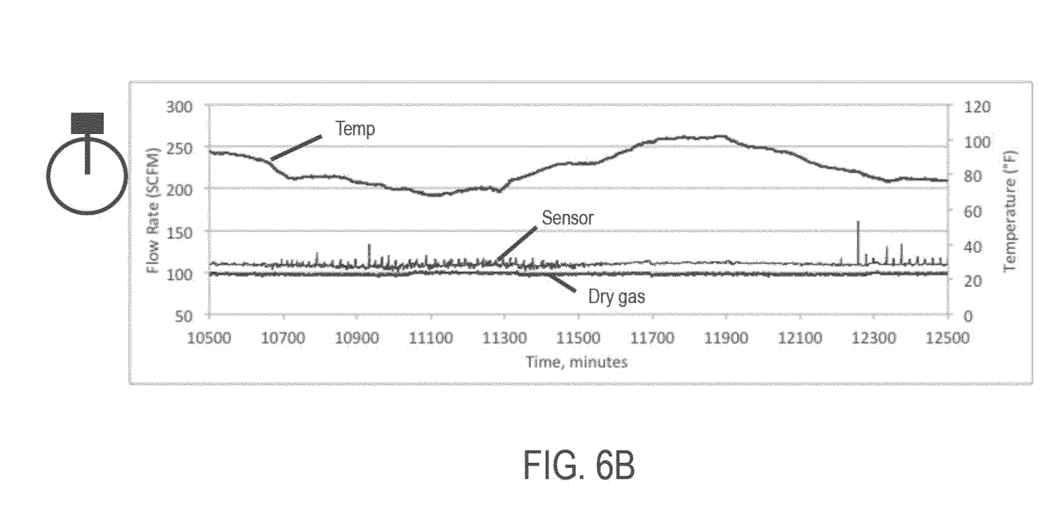

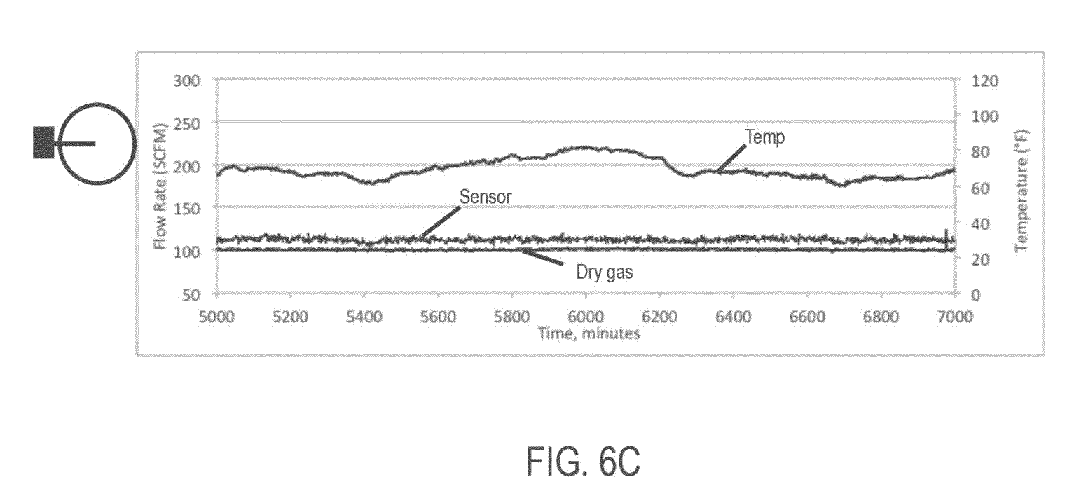

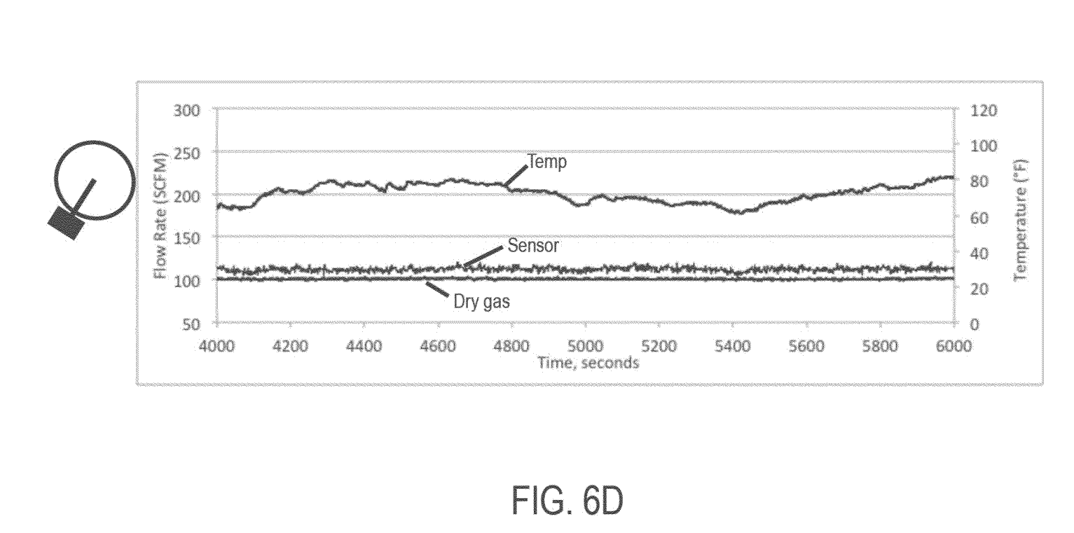

The utility of this innovative concept in an industrial application is shown in FIGS. 6A, 6B, 6C, and 6D, which are graphs of test data from a digester product gas duct in one example of the present disclosure. An anaerobic waste water digester produces a gas flow containing combustible gases that can be used to power combustion engines providing an additional economic return to a wastewater treatment facility. Control of the process and the combustion engines would be substantially improved if the gas flow rate can be accurately measured. This gas stream is typically saturated with water vapor and, as the temperature varies, this water vapor can condense to form a mist in the flow stream making measurement of the flow rate difficult. FIGS. 6A, 6B, 6C, and 6D show data from a series of tests at a digester facility in one example of the present disclosure. In these tests, the location of the sensor being tested is described as positions on a clock with 12:00 o'clock having the sensor inserted from the top of the duct with the sensor pointing down into the flow stream. Similarly, 3:00 o'clock or 9:00 o'clock would have the sensor inserted from one side or the other horizontally, 7:30 o'clock or 4:30 o'clock would have the sensor inserted at an angle of about 45 degrees, and 6:00 o'clock would have the sensor inserted from the bottom pointing up into the duct.

FIG. 6A shows a standard low overheat sensor installed in the digester outlet flow duct with the sensor inserted at the 12:00 o'clock position, that is, the sensor inserted from the top of the pipe with the sensor pointed downward as shown in the cross sectional drawing to the left of the graph. The sensor flow reading is labeled “Sensor” and can be compared to the “Dry Gas” flow rate measured after the digester gas has been “cleaned” to remove water vapor so that the flow rate can be accurately measured. A “Temp” signal represents the temperature sensed by the reference probe. The sensor in FIG. 6A is a conventional thermal anemometer flow sensor with a moderate DeltaT of 50° C. This is termed a moderate overheat or DeltaT since industry practice appears to have DeltaT values of 4 to 20° C.

In FIG. 6B, the sensor was in the same 12:00 o'clock position but DeltaT was increased to 300° C. As can be seen, the sensor signal more closely matched the “Dry Gas” flow rate. In fact, the Dry Gas flow rate should be somewhat lower since cleaning the digester gas will remove some components, particularly water vapor, and cause the flow to be slightly lower. The Sensor signal in FIG. 6B still is somewhat noisy, with some obvious spikes in the 11,100 minutes (min) and 12,300 min regions. These regions are when the temperature was lower resulting in more condensation of the water vapor and a higher level of mist.

In FIG. 6C, the sensor with a DeltaT of 300° C. was moved to the 9:00 o'clock position with the result that the spikes observed when the stream temperature is low are eliminated. An even lower noise level from the sensor with a DeltaT of 300° C. is obtained with the sensor installed at the 7:30 o'clock position as shown in FIG. 6D. The effect of the location, 9:00 o'clock better then 12:00 o'clock and 7:30 o'clock better then 9:00 o'clock, may be due to some collection of water in the flow duct and this water draining down on the sensor or collecting on a cool part of the sensor and draining down to the heated portion. In one example, the sensor is to be placed at a position between the 3:00 o'clock through the 6:00 o'clock and up to the 9:00 o'clock positions. In one example, the sensor is to be placed at a position between the 4:00 o'clock through the 6:00 o'clock and up to the 8:00 o'clock position.

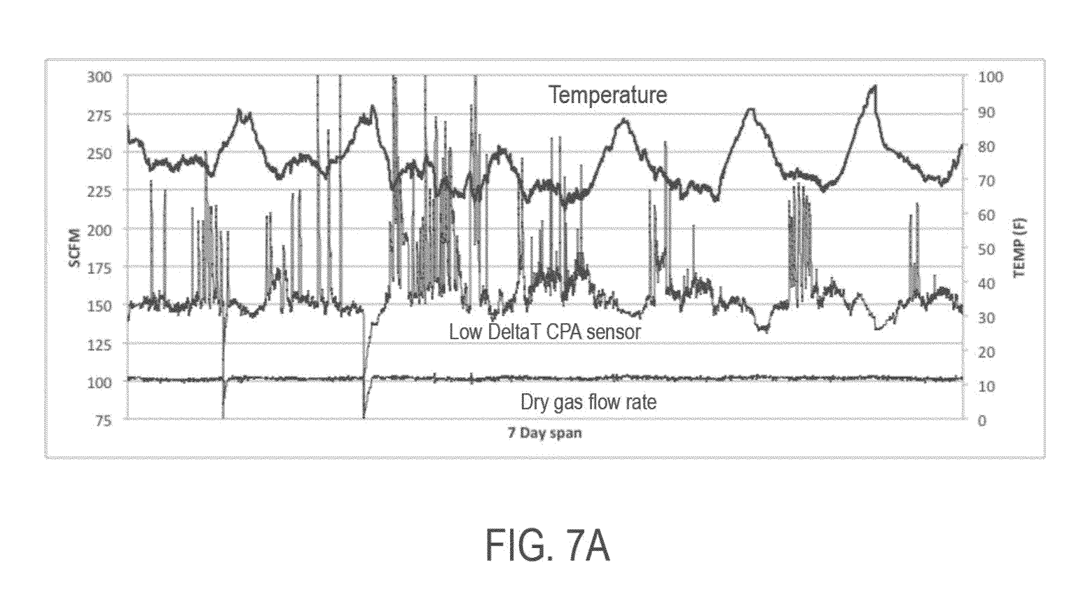

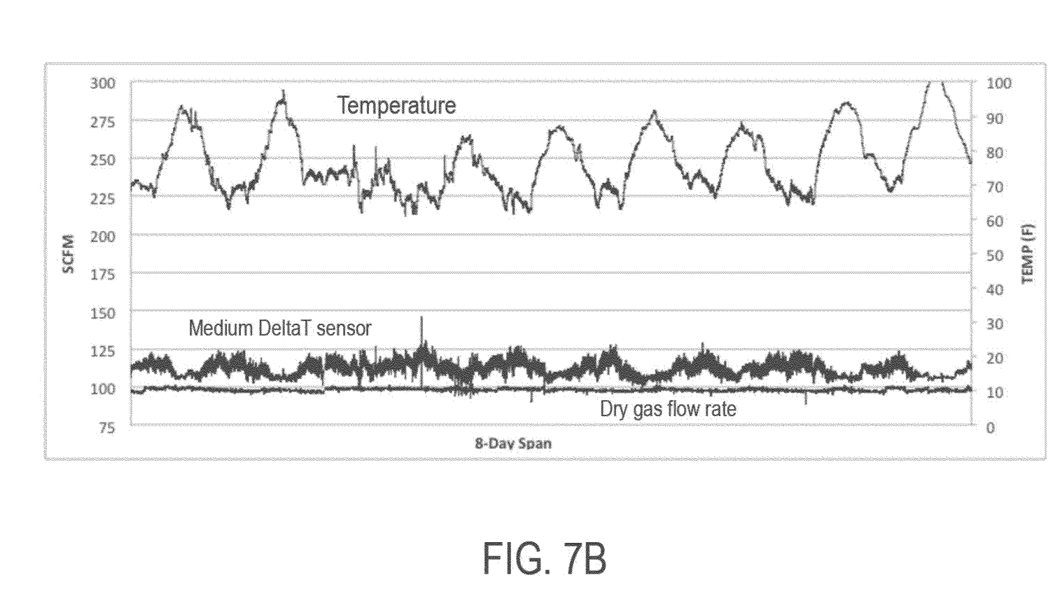

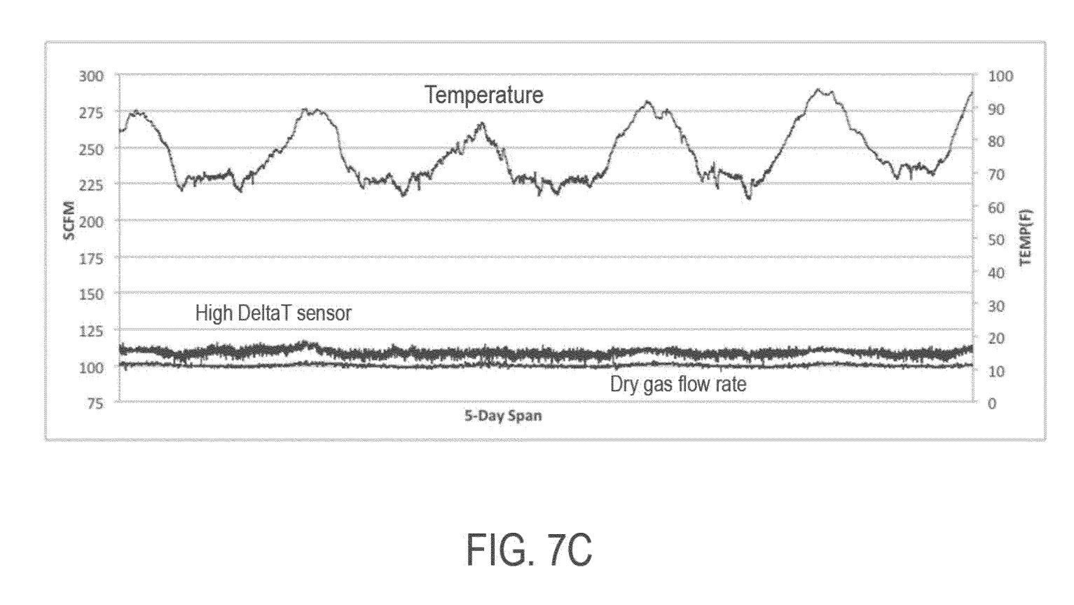

The commercial utility of this inventive operating mode is shown in the data collected in FIGS. 7A, 7B, and 7C in one example of the present disclosure. Three flow sensors operated with different modes and overheats or DeltaT values were compared sequentially in the same digester process for 5 to 7 days over a period of several weeks, in each case installed in the optimum position, 7:30 o'clock. In FIG. 7A, a commercially available low DeltaT constant power anemometer (CPA) type flow sensor was placed in the 7:30 position and flow reading recorded and compared with the dry gas flow. Also on the graph is the temperature profile showing that over a period of 24 hours, the temperature cycles through a peak during the midafternoon. The low DeltaT CPA type sensor is grossly affected by the droplets and mist in the digester gas stream. FIG. 7B shows data for a medium DeltaT sensor in the 7:30 position. Performance is better than the CPA type sensor but this sensor still shows significant variation from the dry gas flow showing flows as high as 20 to 25% above the dry gas flow. FIG. 7C shows the high DeltaT sensor performance. It gives a steady flow reading that matches closely the expected flow which is about 10% above the dry gas flow since removal of the water and other components would decrease the flow 7 to 10%.

In one example of the present disclosure, the operating mode can be applied to any of the known configurations of a thermal anemometer flow sensor. The thermal anemometer flow sensor can have a single probe with both temperature sensing and heated components in the same probe. The thermal anemometer can be operated in a time shared mode where the power to the heated sensor is turned off for some time period so that the probe is effectively unheated and measures the temperature of the flow stream and then heated to the required DeltaT temperature above the flow stream temperature and the heat loss measured and correlated with the gaseous flow rate. The thermal anemometer flow sensor can be operated by any of the known operating modes, such as constant power, constant current, constant temperature, or constant DeltaT. The process would be to operate the device in such a manner that the effective DeltaT is high, in the range of 100 to 1,000° C., 200 to 800° C., or 300 to 600° C. In the constant power mode, the power would be set to a high value to obtain this high DeltaT. In the constant current mode, the current would be set to a high value to obtain this high DeltaT. In the constant temperature mode, the target temperature would be set to the target DeltaT value above the highest expected ambient temperature. In one example of the present disclosure, the operating mode would be a constant DeltaT mode so that changes in the stream temperature would be automatically compensated to maintain a high DeltaT and preserve the intrinsic faster flow change response time of the constant temperature difference method.

The improved operation of this thermal anemometer design is partially due to the reduced influence of liquid on the heat transfer from the heated probe of the sensor. Moving the sensor from the 12:00 o'clock position, which is typical for thermal anemometer flow sensors installed in a duct, to the 7:30 o'clock position is due to reducing or preventing liquid collecting on the colder portions of the heated probe or on the walls of the duct and flowing by gravity downward to the heated portion of the sensor probe leading to a erroneous high flow signal.

The improved performance of a thermal anemometer flow sensor in vapor flows containing condensed liquid droplets is unexpected and innovative. The reason for this improved performance could be understood by considering the amount of heat flowing to convective heating of the vapor flow past the heated sensor and the heat flowing to heat and/or vaporize the liquid that impacts the heated probe. The heat flowing to convective heating of the vapor flow is the heat flow that correlates with the vapor velocity and is calibrated to give vapor velocity in a liquid free vapor flow. When the DeltaT is very high, the heat loss to the convective flow is large. However, the heat loss to liquid impacting the heated probe is dependent on the amount of liquid impacting the heated probe and, as long and the heated probe is above the vaporization temperature of the liquid, this heat flow is independent of the temperature of the heated probe. As the DeltaT is increased, the heat loss to the convective vapor flow velocity is increased while the liquid induced losses do not increase thus reducing the effect of condensed liquid on flow signal. A very high DeltaT results in a signal that is substantially dependent on the vapor velocity and substantially independent of the liquid present in the flow stream. This operating method can be applied to any gaseous stream containing liquid phase droplets or mist and is independent of whether the gaseous stream is saturated with the liquid phase vapor or not.

Most of the testing and the discussion is directed toward the elimination of the effect of mist, small liquid droplet in the size range below 10 micrometers. However, it is expected that operation of the heated sensor at high DeltaT will also reduce the effect of liquid droplet of larger size so that the inventive concept is applicable in gaseous streams with larger liquid droplets.

Various other adaptations and combinations of features of the embodiments disclosed are within the scope of the invention. Numerous embodiments are encompassed by the following claims.

What is claimed is:

1: A method to operate a thermal anemometer flow sensor to measure a property of a stream, comprising:
heating a heated probe of the sensor to a temperature of 100 to 1,000° C. greater than a temperature of the stream; and
determining the property of the stream by measuring a heat loss from the heated probe.

2: The method of claim 1, wherein the heated probe is heated to a temperature of 200 to 600° C. greater than the temperature of the stream.

3: The method of claim 1, further comprising detecting the temperature of the stream with a non-heated probe of the sensor.

4: The method of claim 1, wherein the sensor is operated in a constant DeltaT mode where the heated probe is kept at a constant temperature above the temperature of the stream.

5: The method of claim 1, wherein the sensor is operated in a constant power mode where the heated probe is kept at a constant power.

6: The method of claim 1, further wherein the sensor is operated in a constant current mode where a current to the heated probe is kept constant.

7: The method of claim 1, further wherein the sensor is operated in a constant temperature mode where the heated probe is kept at a constant temperature.

8: The method of claim 1, wherein the property comprises a flow rate or a flow velocity.

9: A flow meter to measure a property of a stream, comprising:
a thermal anemometer sensor including a heated probe;
a controller configured to:
heat the heated probe to a temperature of 100 to 1,000° C. greater than a temperature of the stream; and
determining the property of the stream by measuring a heat loss from the heated probe.

10: The meter of claim 9, wherein the heated probe is heated to a temperature of 200 to 600° C. greater than the temperature of the stream.

11: The meter of claim 9, wherein:
the sensor further comprises a non-heated probe; and
the controller being further configured to detect the temperature of the stream with the non-heated probe.

12: The meter of claim 9, wherein the controller operates the sensor in a constant DeltaT mode where the heated probe is kept at a constant temperature above the temperature of the stream.

13: The meter of claim 9, wherein the controller operates the sensor in a constant power mode where the heated probe is kept at a constant power.

14: The meter of claim 9, wherein the controller operates the sensor in a constant current mode where a current to the heated probe is kept constant.

15: The meter of claim 9, wherein the controller operates the sensor in a constant temperature mode where the heated probe is kept at a constant temperature.

16: The meter of claim 9, wherein the property comprises a flow rate or a flow velocity.

17: The meter of claim 9, wherein the sensor is inserted into a duct between 3:00 and 9:00 o'clock positions.

18: The meter of claim 17, wherein the sensor is inserted into a duct at a 7:30 or 4:30 o'clock position.
